(19) United States
(12) Patent Application Publication
(10) Pub. No.: US 2006/0111969 A1
(43) Pub. Date: May 25, 2006

(54) System and method for automatic selection of advertising slogans printed on a mailpiece

(76) Inventors: Wojciech M. Chrosny, Orange, CT (US); Karen D'Andrea, Norwalk, CT (US)

Correspondence Address: PITNEY BOWES INC.;35 WATERVIEW DRIVE, P.O. BOX 3000, MSC 26-22, SHELTON, CT, 06484-8000, US

(21) Appl. No.: 10/996,275

(22) Filed: Nov. 23, 2004

(51) Int. Cl. G06Q 30/00

(52) U.S. Cl. 705/14

(57) ABSTRACT

A method of printing an ad slogan on a mailpiece, including establishing one or more date ranges and one or more pre-selected ad slogans, wherein each of the date ranges has one of the pre-selected ad slogans corresponding thereto. The method further includes determining a current date (the date on which an ad slogan is to be printed on said mailpiece), determining whether the current date falls within a particular one of the one or more date ranges, and if the current date falls within a particular one of the one or more date ranges, printing on the mailpiece the pre-selected ad slogan that corresponds to the particular one of the one or more date ranges. Also, various mail processing systems for implementing the method, including both traditional and so called virtual mail processing system.

### FIELD OF THE INVENTION

The present invention relates to a system and method for printing information on a mailpiece, and, in particular, to a system and method for automatically selecting advertising slogans to be printed on a mailpiece.

### BACKGROUND OF THE INVENTION

Postage metering systems are well known in the art, and are often incorporated into mail processing systems, such as mailing machines. A typical postage meter applies evidence of postage, commonly referred to as postal indicia, to envelopes or other mailpieces and accounts for the value of the postage dispensed. As is well known, postage meters include an ascending register, that stores a running total of all postage dispensed by the meter, and a descending register, that holds the remaining amount of postage credited to the meter and that is reduced by the amount of postage dispensed during a transaction. The postage meter generally also includes a control sum register which provides a check upon the descending and ascending registers. The control sum register has a running account of the total funds being added into the meter. The control sum register must always correspond with the summed readings of the ascending and descending registers. The control sum register is the total amount of postage ever put into the machine and it is alterable only when adding funds to the meter. In this manner, by inspecting the various registers and securing them from tampering, the dispensing of postal funds may be accurately recorded, tracked and accounted for.

More recently, postage metering systems have been developed where the accounting structure described above is no longer resident with the user. Sometimes referred to as a “virtual postage meter,” these types of postage printing systems dispense postage electronically over suitable communication channels (LAN, WAN, telephone lines, Internet, etc.). The user maintains an account with a remotely located data center (maintained by an authorized postage meter manufacturer) and receives postage securely using appropriate electronic data interchange techniques. At a later time, the user is invoiced for the amount of postage dispensed and any other fees associated with maintaining the account with the data center. Often times, a secret code or token is derived from information particular to the mailpiece (the indicated postage amount, date, recipient address information, etc.) and is incorporated or embedded into the postal indicium for later use by a postal authority in verifying the integrity of the postal indicium. Examples of such systems are described in U.S. Pat. No. 4,725,718 and U.S. Pat. No. 5,454,038.

It is also known to print selected messages (generally referred to as ad slogans, although such messages are not restricted to commercial advertisements) along with postal indicia. Generally, the messages bears no relation to the postal indicia. As used herein, the terms “ad slogan” and “advertising slogan” shall refer to any information, including text and/or graphics, that is printed on a mailpiece along with a postal indicium, including both information for promoting the sale of a particular product or service or a particular company, and general information not related to promoting the sale of a particular product or service or a particular company, such as a seasonal greeting.

In traditional postage meters employing either rotary drum or flat bed printing technology, an ad slogan was printed along with the postal indicium by including an additional printing die representative of the ad slogan. These dies were typically costly to manufacture and distribute and cumbersome for the postage meter user to install. Examples of die based systems for printing messages are disclosed in U.S. Pat. No. 5,168,804 and U.S. Pat. No. 5,024,153. More recently, the postage meter industry has begun to incorporate digital (dot matrix) printing technology which obviates the need for dies as the digital printer may be supplied with suitable drive signals to effect printing of a message. The message included in the drive signals may include selected ad slogans and the like which are to be printed along with a postal indicium. Data for creating a number of such ad slogans is stored in the postage meter and selectively accessed when desired. Examples of digital printing technology based systems for printing messages are disclosed in U.S. Pat. No. 4,831,554 and U.S. Pat. No. 5,509,109.

One problem with existing mail processing systems that enable ad slogans to be printed along with postal indicia is that users must manually select and change, when desired, the particular ad slogans that are used. This is often necessary as many ad slogans are tied to particular, time dependent product promotions or are related to a particular time of the year, such as a holiday greeting. To stay current requires attention and action on the part of the user, a factor that, to many users, is a deterrent to the use of ad slogans on mailpieces. Thus, what is needed is a system and method that simplifies, facilitates and automates the selection and use of multiple ad slogans, particularly those that have time/date period relevance, to increase the use thereof on mailpieces.

### SUMMARY OF THE INVENTION

The present invention relates to a method of printing an ad slogan on a mailpiece, including establishing one or more date ranges and one or more pre-selected ad slogans, wherein each of the date ranges has one of the pre-selected ad slogans corresponding thereto. The method further includes determining a current date (the date on which an ad slogan is to be printed on said mailpiece), determining whether the current date falls within a particular one of the one or more date ranges, and if the current date falls within a particular one of the one or more date ranges, printing on the mailpiece the pre-selected ad slogan that corresponds to the particular one of the one or more date ranges. The printing step may further comprise printing a postal indicium on the mailpiece along with the ad slogan. Furthermore, the ad slogans may comprise a commercial advertisement for the sale of a product or a service, or may comprise a message that does not include a commercial advertisement for the sale of a product or a service, such as a holiday greeting.

The present invention also relates, in one embodiment, to a mail processing system for printing an ad slogan on a mailpiece including a printer, a processor; and a memory. The memory in such a mail processing system stores software executable by the processor, wherein the software includes instructions for implementing the method of the present invention as described herein.

The present invention also relates, in another embodiment, to a mail processing system for printing an ad slogan on a mailpiece that includes a printer, a computing device in operative communication with the printer, and a data center in operative communication with the computing device. The data center includes a processing system having a memory that stores software executable by the processing system. The software includes instructions for enabling the establishment of and the storage of information relating to one or more date ranges and one or more pre-selected ad slogans, wherein each of the one or more dates ranges have one of the one or more pre-selected ad slogans corresponding thereto, determining a current date (as described above), determining whether the current date falls within a particular one of the one or more date ranges, and, if the current date falls within a particular one of the one or more date ranges, providing to the computing device information that may be utilized to cause the printer to print on the mailpiece the pre-selected ad slogan that corresponds to the particular one of the one or more date ranges.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is an isometric view of a mail processing system according to the present invention;

FIG. 2 is a block diagram showing certain components of the mail processing system of FIG. 1;

FIGS. 3 and 4 are flowcharts illustrating the operation of a mail processing system according to the present invention in which ad slogans to be printed on a mailpiece are automatically selected; and

FIG. 5 is a block diagram of an alternate mail processing system according to the present invention.

### DETAILED DESCRIPTION OF THE PREFERRED EMBODIMENTS

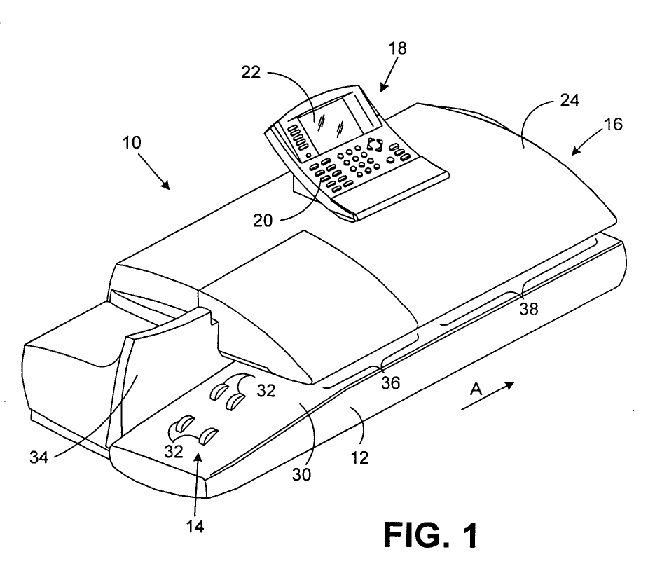

FIG. 1 is an isometric view of a first embodiment of a mail processing system, such as a mailing machine, designated by reference numeral 10 in which the system and method for automatically selecting advertising slogans to be printed on a mailpiece according to the present invention may be implemented. Mailing processing system 10 comprises a base unit, designated generally by the reference numeral 12, the base unit 12 having a mail piece input end, designated generally by the reference numeral 14 and a mail piece output end, designated generally by the reference numeral 16. A UIC 18 is fixedly mounted on the base unit 12, and includes one or more input/output devices, such as, for example, a keyboard 20 and a display device 22. One or more cover members 24 are pivotally mounted on the base 12 so as to move from the closed position shown in FIG. 1 to an open position (not shown) so as to expose various operating components and parts for service and/or repair as needed.

The base unit 12 further includes a horizontal feed deck 30 that extends substantially from the input end 14 to the output end 16. A plurality of nudger rollers 32 are suitably mounted under the feed deck 30 and project upwardly through openings in the feed deck so that the periphery of the rollers 32 is slightly above the upper surface of the feed deck 30 and can exert a forward feeding force on a succession of mail pieces placed in the input end 14. A vertical wall 34 defines a mail piece stacking location from which the mail pieces are fed by the nudger rollers 32 along the feed deck 30 and into a transport mechanism (not shown) that transports the mail pieces in a downstream path of travel, as indicated by arrow A, through one or more modules, such as, for example, a separator module and moistening/sealing module. Each of these modules is located generally in the area indicated by reference numeral 36. The mail pieces are then passed to a metering/printing module located generally in the area indicated by reference numeral 38, and exit the mailing processing system 10 at the output end 16.

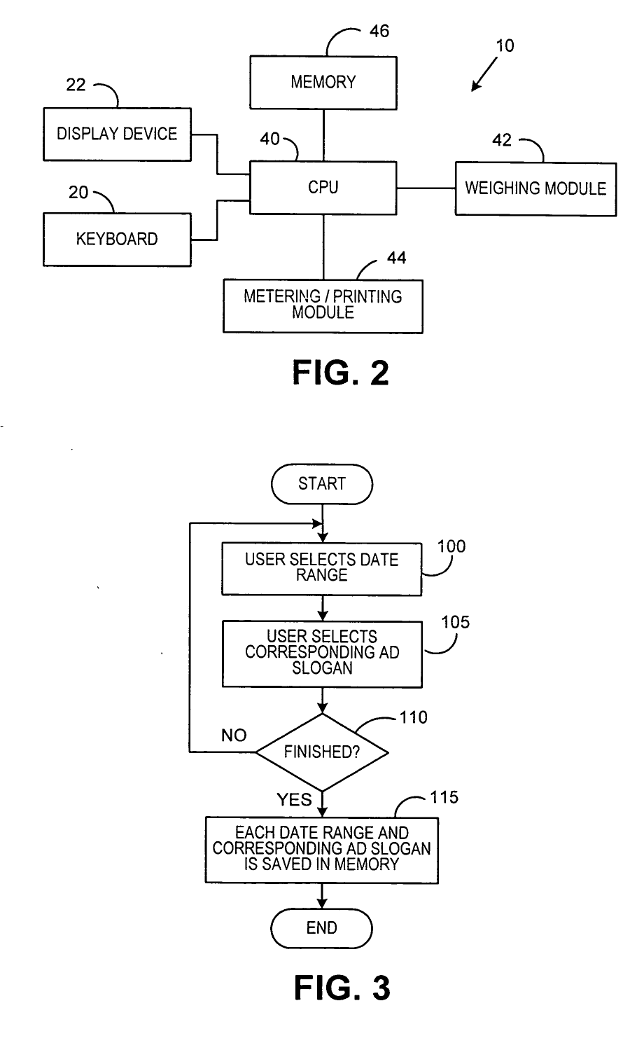

FIG. 2 is a block diagram showing certain components of mail processing system 10. As seen in FIG. 2, mail processing system 10 includes central processing unit (CPU) 40. Display device 22 and keyboard 20 provide a user interface to CPU 40. Weighing module 42, such as a scale, weighs mail pieces and metering/printing module 44, such as postage meter, applies postage to the mail pieces (metering/printing module 44 includes a printer, such as an ink jet print head, for printing postal indicia) and manages postage amounts stored therein. CPU 40 controls all operations of mail processing system 10 as described herein based on software stored in memory 46, such as a non-volatile memory module.

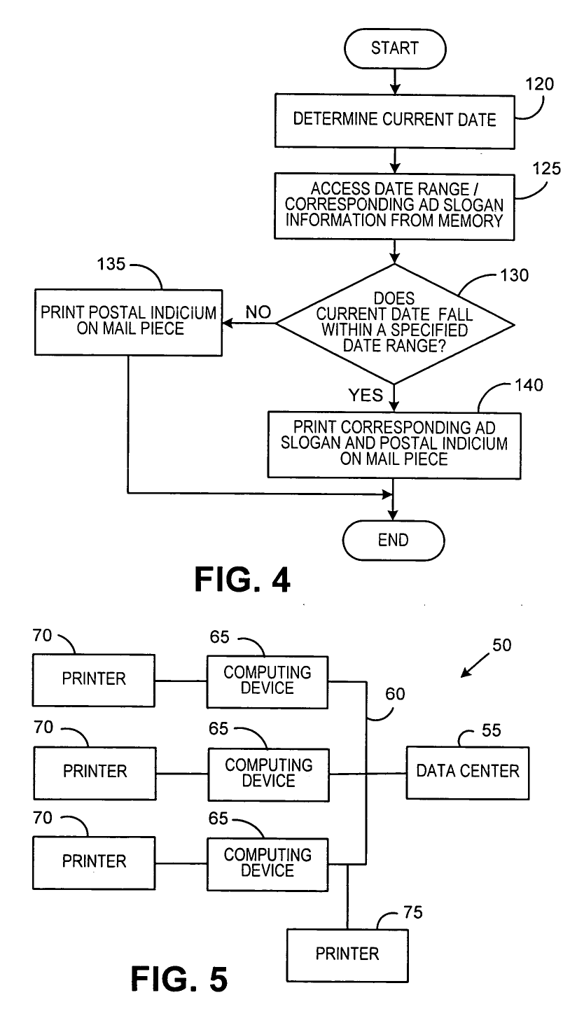

FIGS. 3 and 4 are flowcharts illustrating the operation of mail processing system 10 according to the present invention in which ad slogans to be printed on a mailpiece are automatically selected. In particular, according to the present invention, a user is able to specify, in advance, a set of one or more date ranges throughout the year and associate a particular ad slogan with each specified date range. Preferably, the ad slogans are predefined ad slogans that the user has electronically downloaded into mail processing system 10, and in particular memory 46, from an authorized postage meter manufacturer or some other authorized agency. The ad slogans will typically be stored as a graphics data file representative of the desired message and may be stored in any manner of well known formats, such as: PDF, JPEG, GIF and the like. When a user prints a postage indicium on a mailpiece, the ad slogan that corresponds to the current date (i.e., the ad slogan associated with the specified date range in which the current date falls) is automatically printed on a mailpiece without any further user interaction. As noted above, operation of mail processing system 10 is controlled based on software that is stored in memory 46 and executed by CPU 40. Thus, software implementing the method shown in FIGS. 4 and 5 may be written and stored in memory 46 for execution by CPU 40.

FIG. 3 is a flowchart illustrating a setup process according to the present invention by which a user is able to specify the date ranges and corresponding ad slogans as described above. At step 100, the user begins by specifying the first date range of interest. Preferably, a user is able to do so using the user interface of mail processing system 10 consisting of keyboard 20 and display device 22. Next, at step 105, the user selects the particular ad slogan, previously downloaded by the user and stored in memory 46, that is to be associated with and correspond to the date range selected in step 100. For example, the user my set the first date range as December 26 through January 15, and may associate a “Happy New Year” ad slogan with that date range. Next, at step 110, a determination is made as to whether the user is finished entering date ranges and associated ad slogans. If the answer is no, the process returns to steps 100 and 105, and the user specifies the next date range and associated ad slogan. If, however, the answer at step 110 is yes (all desired date ranges and associated ad slogans have been entered), then, at step 115, information relating to each of the specified date ranges and associated ad slogans is stored in memory 46, preferably in the form of a data table that may be subsequently accessed and searched. Once step 115 is complete, the set up process is over and the user may return to an operational state that allows the printing of postal indicia.

FIG. 4 is a flowchart illustrating a process by which a user is able to print postal indicia along with automatically selected ads slogans using mail processing system 10 according to the present invention. The process shown in FIG. 4 assumes that a mailpiece is ready to have an appropriate postal indicium printed on it, i.e., all other required preliminary steps (.e.g., weighing, sealing, etc.) have been completed. At step 120, the current date is determined (i.e., the date that the postal indicium is being printed), preferably from the internal real time clock provided as part of mail processing system 10. Next, at step 125, CPU 40 accesses the information relating to each of the specified date ranges and associated ad slogans that is stored in memory 40. Then, at step 130, a determination is made as to whether the current date falls within one of the stored date ranges previously specified by the user. If the answer is no, then, at step 135, the appropriate postal indicium is printed on the mailpiece and the process ends (the next mailpiece may be processed). If the answer at step 130 is yes, then, at step 140, the ad slogan associated with the date range in which the current date falls is printed on the mailpiece (using the stored ad slogan data file) along with the appropriate postal indicium and the process ends (the next mailpiece may be processed). Thus, by using the present invention, pre-selected, and preferably date/season appropriate, ad slogans may be automatically printed on mailpieces without any further interaction by the user.

FIG. 5 is a block diagram of a second, alternative embodiment of a mail processing system, designated by reference numeral 50, in which the system and method for automatically selecting advertising slogans to be printed on a mailpiece according to the present invention may be implemented. Mail processing system 50 is indicative of one example of a virtual postage metering environment. Generally, mail processing system 50 includes a data center 55 (including a suitable processing system having one or more memory components for data storage) in communication over any suitable communication network 60 (LAN, WAN, telephone line, internet, etc.) with a plurality of remotely located computing devices 65 (e.g., personal computer, workstation, laptop computer or the like). Generally, it is anticipated that the computing devices 65 would be located in small business offices and/or in private residences and used for a variety of purposes including obtaining postage. The data center 55 is maintained and operated by an authorized postage meter manufacturer or some other authorized agency. The computing devices 65 may be connected directly to a printer 70 or have access to a printer 75 over the suitable communication network 110. Those skilled in the art will recognize that each computing device 65 need not utilize the same network 60 in contacting the data center 55. Likewise, the computing devices 65 may use network 60 with the data center 55 and a different type of network with the printer 75. The remotely located computing devices 65 are representative of users wishing to obtain postage for their mailpieces (envelopes, post cards, packages and the like). Specifically, users are able to download postage from data center 55 and print postal indicia on mailpieces using a printer 70 or 75.

When the method for automatically selecting advertising slogans to be printed on a mailpiece according to the present invention is implemented in mail processing system 50, software for performing the steps shown in FIGS. 3 and 4 may either be stored and executed by the data center 55 (in which case computing devices 65 are known as server based systems), or stored and executed by each computing device 65 (in which case computing devices 65 are known as client based systems having client software stored thereon). Similarly, the ad slogan data files (used for printing the ad slogans) and the information relating to each of the specified date ranges and associated ad slogans established by each user may be stored either at data center 55 in the case of server based systems, or by the respective computing devices 65 in the case of client based systems. In the case of server based systems, the ad slogan data files are provided, when appropriate, to the computing devices 65 over the network 60. Also in the case of server based systems, the setup process described in connection with FIG. 3 is preferably performed by the user over network 60 using a website maintained by the party operating the data center 55.

Thus, according to the present invention, pre-selected, and preferably date/season appropriate, ad slogans may be automatically printed on mailpieces by either a traditional mail processing system such as mail processing system 10 or a virtual mail processing system such as mail processing system 50, thereby eliminating manual user interaction to select ad slogans that was required in the prior art and making the use of ad slogans more convenient for users. With increased convenience will likely come increased use of ad slogans.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method of printing an ad slogan on a mailpiece, comprising:
establishing one or more date ranges and one or more pre-selected ad slogans, each of said one or more date ranges having one of said one or more pre-selected ad slogans corresponding thereto;
determining a current date, said current date being a date on which an ad slogan is to be printed on said mailpiece;
determining whether said current date falls within a particular one of said one or more date ranges; and
if said current date falls within a particular one of said one or more date ranges, printing on said mailpiece the one of said one or more pre-selected ad slogans that corresponds to said particular one of said one or more date ranges.

2. A method according to claim 1, wherein said printing step further comprises printing a postal indicium on said mailpiece.

3. A method according to claim 1, wherein one or more of said one or more pre-selected ad slogans comprises a commercial advertisement for the sale of a product or a service.

4. A method according to claim 1, wherein one or more of said one or more pre-selected ad slogans comprises a message that does not include a commercial advertisement for the sale of a product or a service.

5. A mail processing system for printing an ad slogan on a mailpiece, comprising:
a printer;
a processor; and
a memory, said memory storing software executable by said processor, said software including instructions for:
enabling the establishment of and the storage in said memory of information relating to one or more date ranges and one or more pre-selected ad slogans, each of said one or more date ranges having one of said one or more pre-selected ad slogans corresponding thereto;
determining a current date, said current date being a date on which an ad slogan is to be printed on said mailpiece;
determining whether said current date falls within a particular one of said one or more date ranges; and
if said current date falls within a particular one of said one or more date ranges, causing said printer to print on said mailpiece the one of said one or more pre-selected ad slogans that corresponds to said particular one of said one or more date ranges.

6. A mail processing system according to claim 5, wherein said instructions for causing said printer to print further comprises instructions for causing said printer to print a postal indicium on said mailpiece.

7. A mail processing system according to claim 5, wherein one or more of said one or more pre-selected ad slogans comprises a commercial advertisement for the sale of a product or a service.

8. A mail processing system according to claim 5, wherein one or more of said one or more pre-selected ad slogans comprises a message that does not include a commercial advertisement for the sale of a product or a service.

9. A mail processing system for printing an ad slogan on a mailpiece, comprising:
a printer;
a computing device in operative communication with said printer;
a data center in operative communication with said computing device, said data center having a processing system having a memory, said memory storing software executable by said processing system, said software including instructions for:
enabling the establishment of and the storage of information relating to one or more date ranges and one or more pre-selected ad slogans, each of said one or more dates ranges having one of said one or more pre-selected ad slogans corresponding thereto;
determining a current date, said current date being a date on which an ad slogan is to be printed on said mailpiece;
determining whether said current date falls within a particular one of said one or more date ranges; and
if said current date falls within a particular one of said one or more date ranges, providing to said computing device information that may be utilized to cause said printer to print on said mailpiece the one of said one or more pre-selected ad slogans that corresponds to said particular one of said one or more date ranges.

10. A mail processing system according to claim 9, wherein said providing instructions further includes instructions for providing to said computing device second information that may be utilized to cause said printer to print a postal indicium on said mailpiece.

11. A mail processing system according to claim 9, wherein one or more of said one or more pre-selected ad slogans comprises a commercial advertisement for the sale of a product or a service.

12. A mail processing system according to claim 9, wherein one or more of said one or more pre-selected ad slogans comprises a message that does not include a commercial advertisement for the sale of a product or a service.
